(19) United States
(12) Patent Application Publication
(10) Pub. No.: US 2013/0164647 A1
(43) Pub. Date: Jun. 27, 2013

(54) FUEL CELL SYSTEM, MOTOR, AIR COMPRESSOR, PUMP, AND METHOD OF DESIGNING MOTOR

(71) Applicant: Tomoyoshi Kobayashi, Toyota-shi (JP)

(72) Inventor: Tomoyoshi Kobayashi, Toyota-shi (JP)

(73) Assignee: TOYOTA JIDOSHA KABUSHIKI KAISHA, Toyota-shi (JP)

(21) Appl. No.: 13/821,798

(22) PCT Filed: Sep. 5, 2011
(86) PCT No.: PCT/IB11/02054

§ 371 Date: Mar. 8, 2013

(30) Foreign Application Priority Data
Sep. 10, 2010 (JP) 2010-202748

(51) Int. Cl. H01M 8/04; F01D 25/00

(52) U.S. Cl. CPC H01M 8/04; F01D 25/00
USPC 429/434; 429/513; 415/121.3; 29/592

(57) ABSTRACT

A fuel cell system includes a fuel gas supply/discharge mechanism, an oxidative gas supply/discharge mechanism, and a coolant circulation mechanism that cools a fuel cell. A motor employed in an air compressor of the fuel gas supply/discharge mechanism includes a generally circular cylindrical rotor. The axial length of the rotor is related to its diameter such that the ratio is approximately equal to a maximum value satisfying a relationship: Ta≦Tm, where Ta denotes a permissible torque of the motor, and that Tm denotes a maximum torque for which a request is to be made to the motor.

### BACKGROUND OF THE INVENTION

1. Field of the Invention

The invention relates to a fuel cell system, and more particularly, to an art of coping with load fluctuations.

2. Description of Related Art

In recent years, vehicles equipped with fuel cell systems have been developed. In such vehicles, electric power for propelling the vehicle is supplied by a fuel cell system. However, when the load required of the fuel cell system increases, it becomes necessary to control fluctuations in a rotational speed of an auxiliary motor or the like, and hence the amount of the required electric power increases. In order to ensure the increased required electric power, a fuel cell may be continuously supplied with excess amounts of fuel gas and an oxidative gas, so that electric power generation is carried out in surplus beyond a required load. However, such a configuration reduces fuel efficiency. Thus, electric power for coping with load fluctuations is supplied from a battery.

For example, if the required load increases in response to the operation of an accelerator pedal, the increase in the electric power required for fluctuations in a rotational speed of a motor of a motor-driven air compressor that supplies the fuel cell with the oxidative gas is supplied from the battery. The increase in the electric power increases as the responsiveness to the operation of the accelerator is enhanced and as the output of the fuel cell is raised.

However, because the capacity of the battery is limited, there is a limit to the achievable responsiveness or output performance. Thus, a desired degree of drivability cannot be ensured in some cases, and there have been demands to improve the performance in coping with fluctuations in the load required of the fuel cell system. This problem occurs not only in a motor for the air compressor, but is common to various motors employed in a fuel cell system. Originally, the problem not only occurs in fuel cell systems provided in a vehicle, but also occurs in various fuel cell systems employed for a purpose accompanied by fluctuations in the required load.

### SUMMARY OF THE INVENTION

The invention improves the performance of coping with fluctuations in a load required of a fuel cell system.

The first aspect of the invention relates to a fuel cell system. The fuel cell system includes a fuel cell, a gas supply/discharge mechanism that serves reactive gases for an electrochemical reaction in the fuel cell, and a coolant circulation mechanism that cools the fuel cell. At least one of the gas supply/discharge mechanism and the circulation mechanism employs a motor equipped with a generally circular cylindrical rotor the rotor has a ratio L/D of the axial length L of the rotor to its diameter D is approximately equal to a maximum value that satisfies the relationship: Ta≦Tm, where Ta denotes a permissible torque of the motor and that Tm denotes a maximum torque for which a request is to be made to the motor. The ratio of the axial length L of the rotor to its diameter D has (hereinafter “ratio L/D”) is approximately equal to a maximum value that satisfies the relationship: Ta≦Tm, where Ta denotes the permissible torque of the motor, and Tm denotes the maximum torque for which a request is to be made to the motor.

According to the foregoing aspect of the invention, the motor employed in at least one of the gas supply/discharge mechanism and the circulation-mechanism includes the rotor, and the ratio L/D of the rotor is set approximately equal to the maximum value satisfying the relationship: Ta Tm. That is, the ratio L/D is set approximately equal to the maximum value within such a range that a scheduled maximum torque can be output. The inertia of the rotor decreases as the ratio L/D increases. Therefore, this motor makes it possible to reduce the amount of the electric power needed to perform control to increase the rotational speed of the motor. As a result, when the load required of the fuel cell system increases, the amount of the increase in the electric power needed to perform control to increase the output electric power of the fuel cell system can be reduced. Accordingly, when the increase in the electric power is supplied from an output of an electric power storage device having a limited capacity, the responsiveness to the increase in the required load can be enhanced correspondingly to the reduction in the increase in the electric power. In consequence, the performance of coping with fluctuations in the load required of the fuel cell system is improved. Further, when the fuel cell system is operated at an output to which the increase in the electric power is added, the amount of the added electric power can be reduced. Therefore, the efficiency in utilizing the output of the fuel cell system is enhanced, and the performance of coping with fluctuations in the load required of the fuel cell system can be improved.

In the foregoing aspect of the invention, the fuel cell system may further be equipped with an electric power storage device. The electric power storage device may supply an electric power needed to control fluctuations in a rotational speed of the at least one motor in accordance with fluctuations in a load required of the fuel cell system.

According to the foregoing aspect of the invention, the increase in the electric power needed to perform control to increase the output electric power of the fuel cell system is supplied from the electric power storage device. Therefore, there is no need to operate the fuel cell system at the output to which the increase in the electric power is added. Accordingly, the efficiency in utilizing the output of the fuel cell system is enhanced. Besides, the responsiveness to the increase in the required load can be enhanced correspondingly to the reduction in the inertia of the rotor and the reduction in the increase in the electric power. Therefore, high responsiveness can be realized even when the range of the capacity of the electric power storage device is limited.

A second aspect of the invention relates to a fuel cell system. The fuel cell system is equipped with a fuel cell, a gas supply/discharge mechanism that serves reactive gases for an electrochemical reaction in the fuel cell, a coolant circulation mechanism that circulates coolant for cooling the fuel cell, and an electric power storage device. At least one of the gas supply/discharge mechanism and the circulation-mechanism employs a motor equipped with a generally circular cylindrical rotor. The rotor has a ratio L/D of the axial length L of the rotor to its diameter D is approximately equal to a maximum value that satisfies the relationship: Ta≦Tm, where Ta denotes a permissible torque of the motor and that Tm denotes a maximum torque for which a request is to be made to the motor. The electric power storage device has a maximum capacity within which a scheduled maximum value of an amount of an electric power needed to control fluctuations in a rotational speed of the motor in accordance with fluctuations in a load required of the fuel cell system is set to be confined.

According to the foregoing aspect of the invention, the entire amount of the electric power needed to control fluctuations in the rotational speed of the motor in accordance with fluctuations in the load required of the fuel cell system can be supplied from the electric power storage device. Therefore, there is no need to operate the fuel cell system at the output to which the increase in the electric power is added. Accordingly, the efficiency in utilizing the output of the fuel cell system is enhanced.

In the foregoing aspect of the invention, the ratio L/D may be equal to or larger than 0.5 and equal to or smaller than 6. The ratio L/D of the rotor of the motor of the fuel cell system according to the foregoing aspect of the invention is often within this range.

A third aspect of the invention relates to a motor employed in at least one of a gas supply/discharge mechanism that serves reactive gases for an electrochemical reaction in a fuel cell and a coolant circulation mechanism that circulates coolant for cooling the fuel cell. The motor is equipped with a generally circular cylindrical rotor. The rotor has a ratio L/D of the axial length L of the rotor to its diameter D is approximately equal to a maximum value that satisfies the relationship: Ta≧Tm, where Ta denotes a permissible torque of the motor and that Tm denotes a maximum torque for which a request is to be made to the motor.

A fourth aspect of the invention relates to an air compressor employed in a gas supply/discharge mechanism that serves reactive gases for an electrochemical reaction in a fuel cell. The air compressor is equipped with a motor having a generally circular cylindrical rotor. The rotor has a ratio L/D of the axial length L of the rotor to its diameter D is approximately equal to a maximum value that satisfies the relationship: Ta≦Tm, where Ta denotes a permissible torque of the motor and that Tm denotes a maximum torque for which a request is to be made to the motor.

A fifth aspect of the invention relates to a pump employed in at least one of a gas supply/discharge mechanism that serves reactive gases for an electrochemical reaction in a fuel cell and a coolant circulation mechanism that circulates coolant for cooling the fuel cell. The pump is equipped with a motor having a generally circular cylindrical rotor. The rotor has a ratio L/D of the axial length L of the rotor to its diameter D is approximately equal to a maximum value that satisfies the relationship: Ta≦Tm, where Ta denotes a permissible torque of the motor and that Tm denotes a maximum torque for which a request is to be made to the motor, and that Tm denotes a maximum torque for which a request is to be made to the motor.

A sixth aspect of the invention relates to a method of designing a motor employed in gas supply/discharge mechanism that serves reactive gases for an electrochemical reaction in a fuel cell and a coolant circulation mechanism that circulates coolant for cooling the fuel cell. The method of designing the motor includes setting a ratio L/D of the axial length L of the rotor to its diameter D is approximately equal to a maximum value that satisfies the relationship: Ta≦Tm, where Ta denotes a permissible torque of the motor and that Tm denotes a maximum torque for which a request is to be made to the motor.

### BRIEF DESCRIPTION OF THE DRAWINGS

Features, advantages, and technical and industrial significance of an example embodiment of the invention will be described below with reference to the accompanying drawings, in which like numerals denote like elements, and wherein:

FIG. 1 schematically shows the configuration of a fuel-cell-powered vehicle according to the embodiment of the invention;

FIG. 2 schematically shows the configuration of a motor for an air compressor constituting a fuel cell system according to the embodiment of the invention;

FIG. 3 is a perspective of the outside dimension of a rotor constituting the motor according to the embodiment of the invention; and

FIG. 4 illustrates a method of setting the ratio L/D of the rotor according to the embodiment of the invention.

### DETAILED DESCRIPTION OF EMBODIMENT

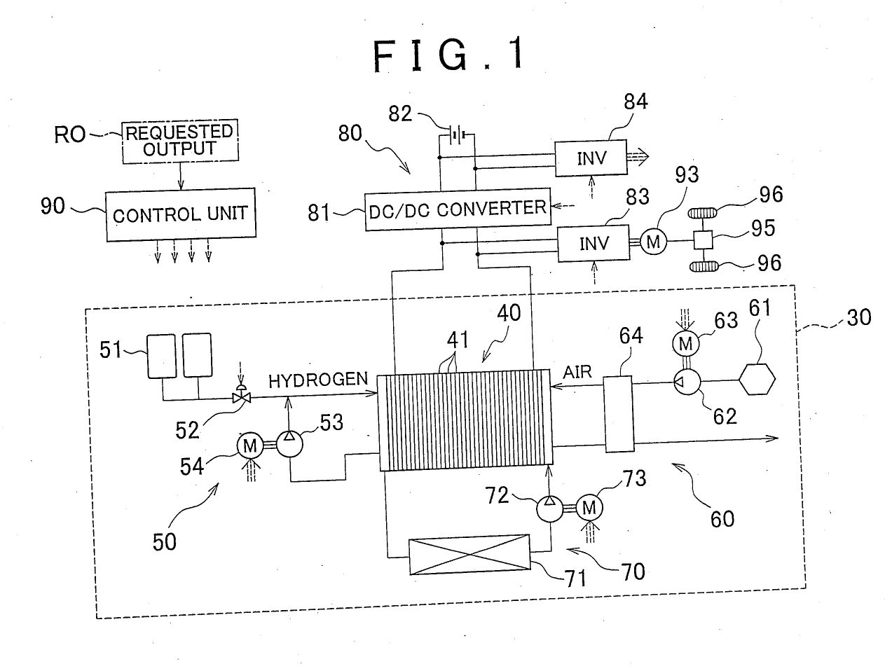

FIG. 1 schematically shows the configuration of a fuel-cell-powered vehicle 20 that is equipped with a fuel cell system 30 according to the embodiment of the invention. The fuel cell system 30 of the fuel-cell-powered vehicle 20 provides power to propel the vehicle 20. As shown in FIG. 1, the fuel-cell-powered vehicle 20 is equipped With the fuel cell system 30, an electric power supply mechanism 80, a control unit 90, and the like.

The fuel cell system 30 generates electricity to propel the fuel-cell-powered vehicle 20 through an electrochemical reaction. As shown in FIG. 1, the fuel cell system 30 includes a fuel cell stack 40, a fuel gas supply/discharge mechanism 50, an oxidative gas supply/discharge mechanism 60, and a coolant circulation mechanism 70.

The fuel cell stack 40 is constructed by laminating a plurality of unit cells 41 on one another and sandwiching each end of the laminated stack of unit cells 41 with terminals equipped with output terminals, insulators, and end plates respectively. Each unit cell 41 is composed of an anode, a cathode, an electrolyte, a separator, and constitutes a minimum unit of electric power generation. Although a proton-exchange membrane fuel cell is employed as each of the unit cells 41 in this embodiment of the invention, other s of fuel cells may also be employed.

The fuel gas supply/discharge mechanism 50 includes a hydrogen tank 51, a regulator 52, and a hydrogen circulation pump 53. The hydrogen gas is stored in the hydrogen tank 51 and supplied to the anode of each unit cell 41 after the pressure and supply amount of the hydrogen gas are regulated by the regulator 52. Exhaust gas from the anode (hereinafter referred to as an anode off-gas) is recirculated to each of unit cell 41 via the hydrogen circulation pump 53. The hydrogen circulation pump 53 includes a motor 54 that drives the hydrogen circulation pump 53. It should be noted that the anode off-gas may be discharged to the outside of the system without being recirculated or intermittently discharged to the outside of the system during recirculation.

The oxidative gas supply/discharge mechanism 60 includes an air cleaner 61, an air compressor 62, and a humidifier 64. Air drawn from the air cleaner 61 is compressed by the air compressor 62, then humidified by the humidifier 64, and supplied to the cathode of each unit cell 41. The air compressor 62 includes a motor 63 that drives the air compressor 62. Exhaust gas from the cathode (hereinafter referred to as a cathode off-gas) is discharged to the outside of the system via the humidifier 64. In this embodiment of the invention, the humidifier 64 includes a water vapor-permeable membrane, and is so constructed as to humidify the air supplied to each unit cell 41 using water vapor from the cathode off-gas that has permeated through the water vapor-permeable membrane. It should be noted that when the anode off-gas is discharged to the outside of the system, the anode off-gas may be mixed with the cathode off-gas before being discharged.

The coolant circulation mechanism 70 includes a radiator 71 and a coolant circulation pump 72. The coolant circulation pump 72 includes a motor 73 that drives the coolant circulation pump 72. The coolant circulation mechanism 70 circulates coolant between the coolant circulation mechanism 70 and each unit cell 41, and repeats the absorption of heat into each of the unit cells 41 and the discharge of heat from the radiator 71 to adjust the operating temperature of each unit cell 41.

The electric power supply mechanism 80 supplies electric power to various components of the fuel-cell-powered vehicle 20, and includes a DC-DC converter 81, a battery 82, and inverters 83 and 84. The DC-DC converter 81 adjusts the output voltage of the fuel cell stack 40 and the output voltage of the battery 82 to a predetermined voltage. The battery 82 is provided as an auxiliary electric power supply. Any surplus electric power generated by the fuel cell system 30 is stored in the battery 82. It is also appropriate to adopt a configuration in which electric power generated by a drive motor 93 during regenerative braking is stored into the battery 82 via the DC-DC converter 81. It should be noted that the auxiliary electric power supply is not limited to the battery, but may be a capacitor or the like. Further, the battery may function as the electric power storage device of the invention.

The inverter 83 converts direct-current electricity from the fuel cell stack 40 and the battery 82, the voltage of which has been raised by the DC-DC converter 81, into three-phase alternating current electricity, and supplies the drive motor 93 with electricity at a predetermined frequency, which is variably controlled. The drive motor 93 drives the driving wheels 96 via a reduction gear 95. The inverter 84 converts direct-current electricity output by the battery 82 and direct-current electricity output by the fuel cell stack 40, the voltage of which has been lowered by the DC-DC converter 81, into three-phase alternating current electricity, and supplies the auxiliary motors, for example, motors 54, 63, and 73 with electricity at a predetermined frequency, which is variably controlled. An inverter 84 is provided for each auxiliary motor.

The components of the fuel-cell-powered vehicle 20 described above are controlled/operated by a control unit 90. The control unit 90 may be an electrical control unit (an ECU) comprising a CPU, a RAM, and a ROM. Upon receiving an requested output RO via an accelerator (not shown), the control unit 90 outputs a drive signal to components of the fuel cell system 30 (e.g., the regulator 52 and the motors 54, 63, and 73), components of the electric power supply mechanism 80 (e.g., the DC-DC converter 81 and the inverters 83 and 84), to control the overall operation of the fuel-cell-powered vehicle 20. Although the control unit 90 in this embodiment of the invention includes a control unit that controls the fuel cell system 30 that is integrated with a control unit that controls the operation of the fuel-cell-powered vehicle 20 these control units may be provided separately.

In this embodiment of the invention, the control unit 90 controls the output of the fuel cell system 30 in accordance with the requested output RO. When a driver depresses an accelerator pedal to accelerate vehicle 20, the control unit 90 accepts the corresponding requested output RO, and executes controls to increase the amount of electric power generated by the fuel cell system 30. More specifically, the control unit 90 sends a signal to the inverter 84 to increase the rotational speeds of the motors 54 and 63 through VVVF control. Thus, the amount of fuel gas and oxidative gas supplied increases, which increases the amount of electric power generated. In this case, according to need, the control unit 90 regulates the opening degree of the regulator 52 to supply the fuel gas from the hydrogen tank 51. The control unit 90 increases the rotational speed of the motor 73 to increase the circulation speed of coolant caused to circulate by the coolant circulation mechanism 70. The control is executed to avoid excessive temperature increases of the fuel cell stack 40 as the amount of electric power generated increases.

As described above, in order to increase the rotational speeds of the motors 54, 63, and 73, the electric power required by the fuel-cell-powered vehicle 20 is increased by an increase in electric power consumption resulting from the increase in the rotational speeds of the motors 54, 63, and 73. Electricity from the battery 82 is used to supply the additional electric power.

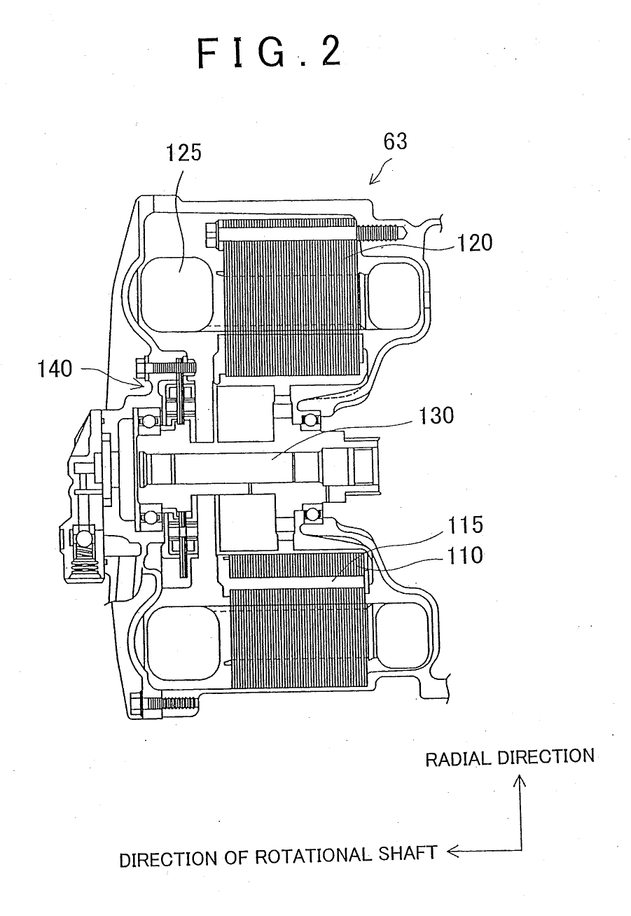

FIG. 2 shows the schematic configuration of the motor 63 for the air compressor 62. FIG. 2 shows the cross-section of the motor 63. In this embodiment of the invention, the motor 63 is a permanent magnet-synchronous motor. However, the motor 63 is not limited to any particular, but can be designed as an alternating-current motor of any one of various. Originally, in the case where a direct-current electric power is input, a direct-current motor may be employed. As shown in FIG. 2, the motor 63 includes a rotor 110, a stator 120, a shaft 130, and a resolver 140.

The rotor 110 is constructed by forming a through-hole in a generally circular cylindrical rotor core composed of a plurality of steel plates laminated on one another, and inserting a permanent magnet 115 into the through-hole. The stator 120 is arranged radially outwardly of the rotor 110. The stator 120 is constructed by winding exciting coil windings around a stator core composed of a plurality of steel plates laminated on another. At both ends of the stator core, in the direction of a rotational shaft thereof, the exciting coil windings form a coil end 125, which is formed through pressurization. It should be noted that the motor 63 is of an inner rotor as is apparent from the above description, but may be of an outer rotor. When the inverter 84 applies an alternating-current voltage to the exciting coil windings of the stator 120 via, a revolving magnetic field corresponding to the alternating-current voltage is generated, and the rotor 110 rotates. The shaft 130 is coupled to the stator 120 and rotates to generate an air compression driving force in the air compressor 62. The resolver 140 detects the rotational angle at which a resolver rotor attached to the shaft 130, rotates in the same phase as the rotor 110, based on the voltage induced in the coil windings.

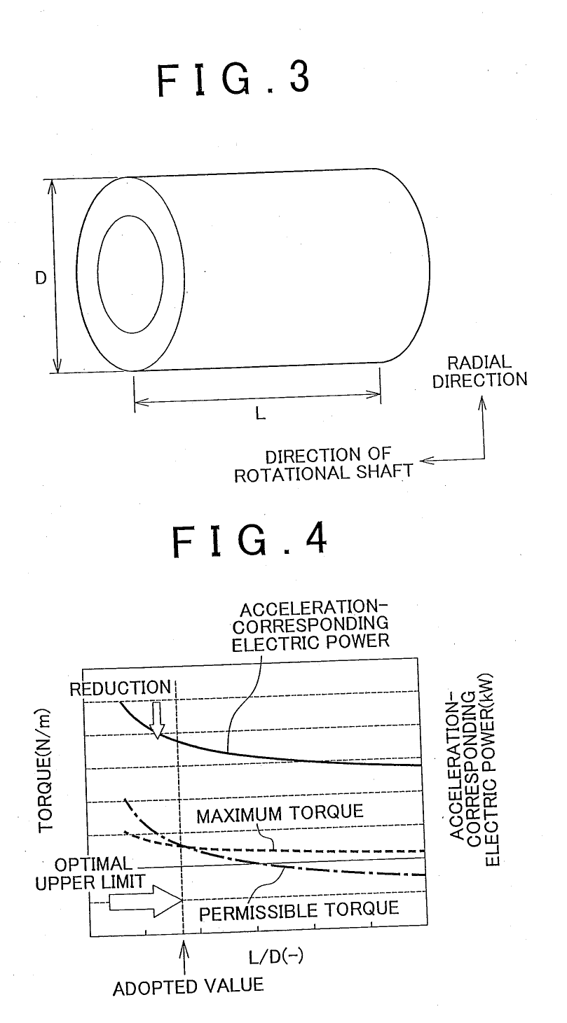

FIG. 3 shows an outside dimension of the rotor 110 employed in this motor 63. As shown in FIG. 3, the rotor 110 is generally circular cylindrical in shape. The rotor 110 has an axial length L along its rotational shaft and a diameter D, and the ratio of L to D (hereinafter “ratio L/D”) is generally equal to a predetermined value. Specifically, Ta denotes a permissible torque of the motor 63 and Tm denotes a maximum torque for which a request is to be made to the motor 63, and the ratio L/D is set at a maximum value that satisfies the relationship: Ta Tm. It should be noted that although not described in detail, the ratio L/D of the rotor is set in the same manner as to the motors 54 and 73 as well. It should be noted that the permissible torque Ta may be an upper limit of a torque that can be output. Further, the maximum torque Tm for which the request is to be made may be the maximum torque of a load request to be made to the fuel cell system. In addition, both the permissible torque Ta and the maximum torque Tm for which the request is to be made may be values set in terms of design. That is, the permissible torque Ta may be the upper limit of a set torque that can be output in terms of design, and the maximum torque Tm for which the request is to be made may be a maximum torque of a load request in designing an employed fuel cell.

A reason why the value L/D is thus set will be described using. FIG. 4. As the requested output RO increases, the electric power needed to increase the rotational speed of the motor 63 (hereinafter referred to also as an acceleration-corresponding electric power) fluctuates in accordance with the inertias of the motor 63 and the air compressor 62, a set response time, and work done by the air compressor 62. The inertia of the rotor 110 of the motor 63 may be calculated using equations (1) and (2), for example, where W represents the mass of the rotor 110 and d represents the inner diameter of the rotor 110.

Inertia of Circular Plate J=⅛·WD² (1)

Inertia of Hollow Circular Cylinder J= 1/12·W(D²+d²) (2)

As is apparent from equations (1) and 2) as well, the inertia of the rotor 110 is unaffected by the value L, and increases as the value D increases. That is, the inertia of the rotor 110 decreases as the value at which the ratio L/D is set increases, namely, as the generally circular cylindrical shape of the rotor 110 becomes relatively elongated. For this reason, as shown in FIG. 4, the acceleration-corresponding electric power may be reduced as the value at which the ratio L/D is set is increased. It should be noted that dotted lines of FIG. 4 indicate the maximum torque Tm for which the request is to be made to the motor 63, and the chain lines of FIG. 4 indicate the permissible torque Ta of the motor 63.

However, if the ratio L/D is increased, the number of slots that can be ensured of the stator 120 decreases, which reduces the amount of torque that can be produced. Accordingly, as shown in FIG. 4, the permissible torque Ta decreases as the ratio L/D increases. Thus, in this embodiment of the invention, the ratio L/D is set at the maximum value that satisfies the relationship: Ta a Tm, namely, the ratio L/D corresponding to a relationship: Ta =Tm. By thus setting the ratio L/D within such a range that the maximum torque Tm can be output, the acceleration-corresponding electric power may be minimized in a relationship between the ratio L/D and the acceleration-corresponding electric power. In other words, the ratio L/C is set within such range that the performance required of the air compressor 62 is not deteriorated. It should be noted that in conventional methods of designing a motor, the effect of the ratio L/D on the acceleration-corresponding electric power is generally not considered. The appropriate value of the ratio L/D may vary depending on the, designing specification, and the like of the motor, but is generally between 0.5 and 6.0. Although the ratio L/D may be set to the value corresponding to the relationship: Ta=Tm, it may also be set to a value close to the maximum value satisfying the relationship: Ta≦Tm, as long as desired responsiveness can be realized. For example, the L/D ratio may be equal to 90% of the maximum value satisfying the relationship: Ta≦Tm.

In the fuel cell system 30, the ratio L/D of the rotor 110 of the motor 63 employed in the oxidative gas supply/discharge mechanism 60 is set at the maximum value that satisfies the relationship: Ta≦Tm. The inertia of the rotor 110 decreases as the ratio L/D increases. Therefore, less electric power is needed to increase the rotational speed of the motor 63 to the maximum possible extent in relation to the ratio L/D. As a result, when the load required of the fuel cell system increases, the acceleration-corresponding electric power needed in performing the control to increase the output electric power of the fuel cell system 30 may be reduced. Further, because the ratio L/D of the rotor is set in the same manner as to the motors 54 and 73 as well, which are employed in the fuel gas supply/discharge mechanism 50 and the coolant circulation mechanism 70 respectively, similar effects are obtained. Because the capacity of the battery 82 is limited, the acceleration-corresponding electric power may be supplied from the battery 82 only within a range corresponding thereto. However, according to the configuration of this embodiment of the invention, the responsiveness to an increase in the requested output RO may be enhanced by reducing the the acceleration-corresponding electric power that is required. Further, if there is no need to enhance the responsiveness by decreasing the acceleration-corresponding electric power, the electric power consumption decreases. Therefore, the fuel efficiency of the fuel cell system 30 may be enhanced.

Further, the fuel cell system 30 supplies the acceleration-corresponding electric power from the battery 82. Therefore, there is no need to operate the fuel cell system 30 at an output to which the acceleration-corresponding electric power is added. Accordingly, the efficiency in utilizing the output of the fuel cell system 30 is enhanced, and as a result, the fuel efficiency of the fuel cell system 30 is enhanced.

Modified examples of the above embodiment will be described. In the above embodiment, the ratio L/D of the rotor 110 is set at the maximum value satisfying the relationship: Ta≦Tm. However, the invention is not restricted to the particulars of this configuration. The ratio L/D may be set such that the relationship: Ta≦Tm is satisfied, and that the scheduled maximum value of the amount of the electric power needed to control fluctuations in the rotational speed of the motor 63 in accordance with fluctuations in the load required of the fuel cell system 30 is confined within a range of a maximum capacity of the battery 82. The same holds true for the motors 54 and 73. Thus, likewise, the responsiveness to increases in requested output RO may be enhanced within a range to the decrease in the acceleration-corresponding electric power.

In the embodiment of the invention configured as described above, each motor 54, 63, and 73 employed in the fuel gas supply/discharge mechanism 50, the oxidative gas supply/discharge mechanism 60, and the coolant circulation mechanism 70, respectively, includes a rotor having ratio L/D indicated above. However, at least one of the motors provided in the fuel gas circulation mechanism 50, the oxidative gas circulation mechanism 60, and the coolant circulation mechanism 70 may include the above-described rotor. Likewise, in this case the above-described effect may be obtained to a predetermined degree. As a matter of course, however, it is desirable to apply the invention to all the motors, because the effect of the invention is obtained to the maximum possible extent.

In the configuration of the above-described embodiment of the invention, the acceleration-corresponding electric power is supplied from the output from the battery 82. However, the invention is not restricted to this configuration. For example, a configuration may be adopted in which the fuel cell system 30 is constantly operated to supply the acceleration-corresponding electric power from the fuel cell system 30, so that the output to which the assumed acceleration-corresponding electric power is added is obtained in addition to the requested output RO. In this configuration as well, the acceleration-corresponding electric power may be reduced in comparison to when a conventional motor is employed, which enhances the fuel efficiency of the fuel-cell-powered vehicle 20. Of course, some of the acceleration-corresponding electric power may be supplied by the battery 82, and the remainder may be supplied from the electric power added to the output of the fuel cell system 30.

The fuel cell system 30 according to the above embodiment is described in the context of a fuel-cell-powered vehicle 20. However, the fuel cell system 30 may be provided in another movable body, for example, a two-wheeled motor vehicle or the like. Originally, the fuel cell system 30 should not necessarily be mounted in a movable body, but the invention can be suitably applied to various electric power consuming devices mounted with the fuel cell system 30 without being accompanied by a commercial electric power supply.

Although an embodiment of the invention has been described above, the components of the invention in the described embodiment that are not recited in the independent claims are supplemental elements which can be appropriately omitted or combined with one another. In addition, it should be understood that the invention is not restricted to the particulars of the described embodiment, and may be suitably modified without departing from the scope of the invention. For example, the invention is not limited to the proton-exchange membrane fuel cell as described in the embodiment, but may be employed in various fuel cells such as a direct methanol-fuel cell, a phosphoric-acid fuel cell, and the like. Further, the invention may also be implemented as a method of designing a motor employed in a fuel cell system.

1. A fuel cell system comprising:
a fuel cell;
a gas supply/discharge mechanism that serves reactive gases for an electrochemical reaction in the fuel cell; and
a coolant circulation mechanism that circulates coolant for cooling the fuel cell,
wherein at least one of the gas supply/discharge mechanism and the coolant circulation mechanism employs a motor that includes with a generally circular cylindrical rotor, and
the rotor has a ratio L/D of the axial length L of the rotor to its diameter D is approximately equal to a maximum value that satisfies the relationship: Ta≦Tm, where Ta denotes a permissible torque of the motor and that Tm denotes a maximum torque for which a request is to be made to the motor.

2. The fuel cell system according to claim 1, further comprising
an electric power storage device,
wherein the electric power storage device supplies electric power needed to control fluctuations in rotational speed of the motor in accordance with fluctuations in a load on the fuel cell system.

3. A fuel cell system comprising:
a fuel cell;
a gas supply/discharge mechanism that serves reactive gases for an electrochemical reaction in the fuel cell;
a coolant circulation mechanism that circulates coolant for cooling the fuel cell; and
an electric power storage device,
wherein at least one of the gas supply/discharge-mechanism and the coolant circulation-mechanism employs a motor equipped with a generally circular cylindrical rotor,
the rotor has a ratio L/D of the axial length L of the rotor to its diameter D is approximately equal to a maximum value that satisfies the relationship: Ta Tm, where Ta denotes a permissible torque of the motor and that Tm denotes a maximum torque for which a request is to be made to the motor, and
the electric power storage device has a maximum capacity within which a scheduled maximum value of an amount of an electric power needed to control fluctuations in a rotational speed of the motor in accordance with fluctuations in a load required of the fuel cell system is set to be confined.

4. The fuel cell system according to claim 2, wherein the electric power storage device is a battery.

5. The fuel cell system according to claim 1, wherein the ratio L/D is equal to or larger than 0.5 and equal to or smaller than 6.

6. A motor employed in at least one of a gas supply/discharge mechanism that serves reactive gases for an electrochemical reaction in a fuel cell and a coolant circulation mechanism that circulates coolant for cooling the fuel cell, the motor comprising:
a generally circular cylindrical rotor,
wherein the rotor has a ratio L/D of the axial length L of the rotor to its diameter D is approximately equal to a maximum value that satisfies the relationship: Ta≦Tm, where Ta denotes a permissible torque of the motor and that Tm denotes a maximum torque for which a request is to be made to the motor.

7. An air compressor employed in a gas supply/discharge mechanism that serves reactive gases for an electrochemical reaction in a fuel cell, the air compressor comprising:
a motor having a generally circular cylindrical rotor,
wherein the rotor has a ratio L/D of the axial length L of the rotor to its diameter D is approximately equal to a maximum value that satisfies the relationship: Ta≦Tm, where Ta denotes a permissible torque of the motor and that Tm denotes a maximum torque for which a request is to be made to the motor.

8. A pump employed in at least one of a gas supply/discharge mechanism that serves reactive gases for an electrochemical reaction in a fuel cell and a coolant circulation mechanism that circulates coolant for cooling the fuel cell, the pump comprising:
a motor having a generally circular cylindrical rotor,
wherein the rotor has a ratio L/D of the axial length L of the rotor to its diameter D is approximately equal to a maximum value that satisfies the relationship: Ta Tm, where Ta denotes a permissible torque of the motor and that Tm denotes a maximum torque for which a request is to be made to the motor.

9. A method of designing a motor employed in at least one of a gas supply/discharge mechanism that serves reactive gases for an electrochemical reaction in a fuel cell and a coolant circulation mechanism that circulates coolant for cooling the fuel cell, the method comprising:
setting a ratio L/D of the axial length L of the rotor to its diameter D is approximately equal to a maximum value that satisfies the relationship: Ta≦Tm, where Ta denotes a permissible torque of the motor and that Tm denotes a maximum torque for which a request is to be made to the motor.
